(19) United States
(12) Patent Application Publication
(10) Pub. No.: US 2006/0209683 A1
(43) Pub. Date: Sep. 21, 2006

(54) Packet transmission method and station in packet ring telecommunications network

(75) Inventor: Kazuto Nishimura, Kawasaki (JP)

Correspondence Address: BINGHAM MCCUTCHEN LLP, 3000 K STREET, NW, BOX IP, WASHINGTON, DC, 20007, US

(73) Assignee: Fujitsu Limited

(21) Appl. No.: 11/217,302

(22) Filed: Sep. 2, 2005

(30) Foreign Application Priority Data
Mar. 18, 2005 (JP) 2005-080437

(51) Int. Cl. H04L 1/00

(52) U.S. Cl. 370/222

(57) ABSTRACT

A station forming part of a packet ring telecommunications network designed to share available bandwidth of packets transmitted in a first direction through a 0-side transmission line based on information indicated in control frames transmitted in a second direction in an opposite direction to the first direction through a 1-side transmission line forming a double ring together with the 0-side transmission line, provided with a transmission line switching function unit for switching from the 0-side transmission line to the 1-side transmission line to transmit packets to be transmitted and a switching instruction function unit for holding a switching condition of whether or not to start the transmission line switching operation and giving an instruction to start the transmission line switching operation to the transmission line switching function unit when referring to at least the information indicated in the control frames and judging that the switching condition is satisfied and a method for the same, whereby use of an opposite side transmission line not prescribed in standards of RPR networks is enabled without causing trouble on the RPR network and further an increase of the throughput is achieved.

### BACKGROUND OF THE INVENTION

1. Field of the Invention

The present invention relates to packet transmission method in a packet ring telecommunications network, more particularly a resilient packet ring (RPR) network, and a station configuring the network.

2. Description of the Related Art

A resilient packet ring (RPR) is a packet ring telecommunications network comprising double-ring type 0-side and 1-side transmission lines and a plurality of stations inserted into these transmission lines and now being standardized in IEEE 802.17.

This RPR network is a new double ring type network guaranteeing a 50 ms switching time of transmission lines when a fault occurs, almost equivalent to that guaranteed in a conventional SONET ring network, and enabling the available bandwidth of the transmission lines to be shared among a plurality of stations (that is, among users), that is, the merits of a packet ring telecommunications network.

Note that, as an example of known techniques concerning an RPR network, there is the Japanese Unexamined Patent Publication (Kokai) No. 2004-289799. Japanese Unexamined Patent Publication (Kokai) No. 2004-289799 proposes a novel technique for bandwidth management and flow control on the network and realizes highly efficient operation of the RPR network.

Japanese Unexamined Patent Publication (Kokai) No. 2004-289799 modifies the techniques of bandwidth management and flow control as explained above in order to run an RPR network with a high efficiency.

However, there is a problem that striking improvement of packet transmission efficiency is difficult by just modifying the bandwidth management and flow control described above.

### SUMMARY OF THE INVENTION

Accordingly, an object of the present invention is to realize a packet ring telecommunications network (particularly an RPR network) enabling striking improvement of packet transmission efficiency, that is, a striking increase of throughput. Another object is to realize this by an extremely simple technique making use of the inherent function of an RPR network.

To attain the above objects, as will be explained in detail later by using the drawings, according to the present invention, there is provided a packet ring telecommunications network, particularly an RPR network, having a double-ring type 0-side transmission line and 1-side transmission line and a plurality of stations inserted into these transmission lines, wherein when congestion occurs in the packet transmission using the 0-side transmission line, taking note of use of the opposite side transmission line, i.e., 1-side transmission line, not prescribed on the RPR network, all or part of the traffic on the 0-side transmission line is transferred (interchanged) to the 1-side transmission line and the packet transmission is handled there.

In this case, the technique for allotting all or part of the packet transmission using one of the two double ring transmission lines to the other transmission line is probably itself well known. In practice, however, as will be explained later by using the drawings, it is not easy to realize this allocation without network trouble. Accordingly, the present invention transfers the load of the packet transmission from one transmission line to the other transmission line without network trouble at the time of congestion of traffic by as simple a technique as possible.

As will be explained in detail later, the present invention makes it possible to use the opposite side transmission line not prescribed in the RPR network standard without trouble on the RPR network by introducing an adjustment mechanism 10 of FIG. 3 explained later. Due to this, the probability of occurrence of congestion in traffic of users of the RPR network is reduced and a further increase of the throughput can be realized.

### BRIEF DESCRIPTION OF THE DRAWINGS

These and other objects and features of the present invention will become clearer from the following description of the preferred embodiments given with reference to the attached drawings, wherein:

FIG. 1 is a first part of a view for explaining the fundamental problem in the basic concept of the present invention;

FIG. 2 is a second part of a view for explaining the fundamental problem in the basic concept of the present invention;

FIG. 3 is a view summarizing an adjustment mechanism formed in a station;

FIG. 4 is a view of an example of the configuration of an RPR network to which the present invention is applied;

FIG. 5 is a first view representing the functions of a switching instruction function unit by a hardware image;

FIG. 6 is a second view representing the functions of a switching instruction function unit by a hardware image;

FIG. 7 is a third view representing the functions of a switching instruction function unit by a hardware image;

FIG. 8 is a fourth view representing the functions of a switching instruction function unit by a hardware image;

FIG. 9 is a view representing prior investigation of an opposite side transmission line by a flooding unit;

FIG. 10 is a view of the situation at the time of complete transfer to the opposite side transmission line;

FIG. 11 is a view of the situation at the time when congestion occurs in the opposite side transmission line of FIG. 10;

FIG. 12 is a view of the situation at the time of switchback to an original transmission line due to the congestion of FIG. 11;

FIG. 13 is a flow chart of the packet transmission method according to the present invention;

FIG. 14 is a flow chart of a typical example of the packet transmission method according to the present invention;

FIG. 15 is a view of an example of the actual configuration of a station;

FIG. 16 is a view of an example of the actual configuration of a switch control means in FIG. 15;

FIG. 17 is a view for generally explaining an RPR network;

FIG. 18 is another view for generally explaining an RPR network; and

FIG. 19 is still another view for generally explaining an RPR network.

### DESCRIPTION OF THE PREFERRED EMBODIMENTS

Preferred embodiments of the present invention will be described in detail below while referring to the attached figures. In order to facilitate understanding of the present invention, first, a general explanation will be given of a packet ring telecommunications network (hereinafter an RPR network as tan example).

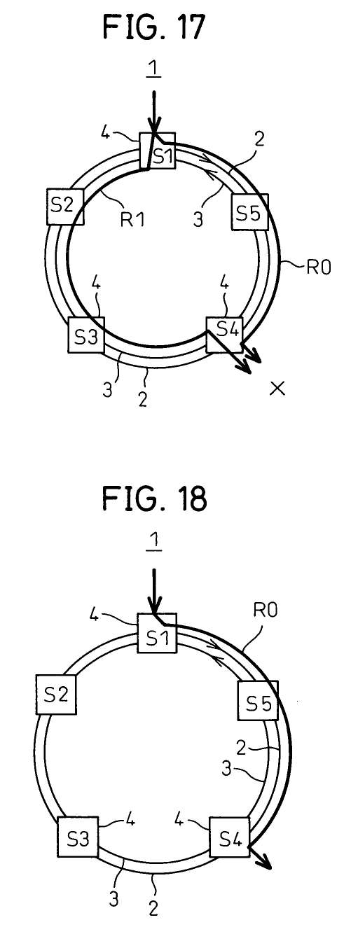

FIG. 17 to FIG. 19 are view for generally explaining an RPR network.

Referring to FIG. 17 first, reference numeral 1 represents an RPR network. This network is configured by a double-ring type 0-side transmission line 2 and 1-side transmission line 3 and a plurality of stations 4 inserted into these transmission lines. In the figure, five stations S1 to S5 are illustrated. Here, the direction of the flow of information on the 0-side transmission line 2, and the direction of the flow of information on the 1-side transmission line 3 are opposite to each other.

In a network having the configuration as described above, if assuming that a data transmission request is issued from a user (not illustrated) under a first station (S1) 4, since this network uses the double-ring transmission lines 2 and 3, as routes for transmission of the packets in response the data transmission request, there are the two routes of R (Ringlet) 0 and R (Ringlet) 1 as indicated by the arrows in the figure.

This means that packets in response to the data transmission request could be sent through both of the route R0 and the route R1. However, if packets flow through both R0 and R1 in this way, the packets will end up overlapping at the destination fourth station (S4) 4. This overlap is indicated by the mark X in the figure.

Accordingly, in the RPR network 1, in order to avoid such overlap (X), it is decided that only one of the route R0 or R1 will be used for a single packet transmission. Then, when deciding this, the route having the smaller number of stations through which the data would pass, that is, the route having the smaller number of hops, is selected with priority. Accordingly, in the example of FIG. 17, the packets are transmitted through the route R0 as shown in FIG. 18 up to the destination station (S4) 4.

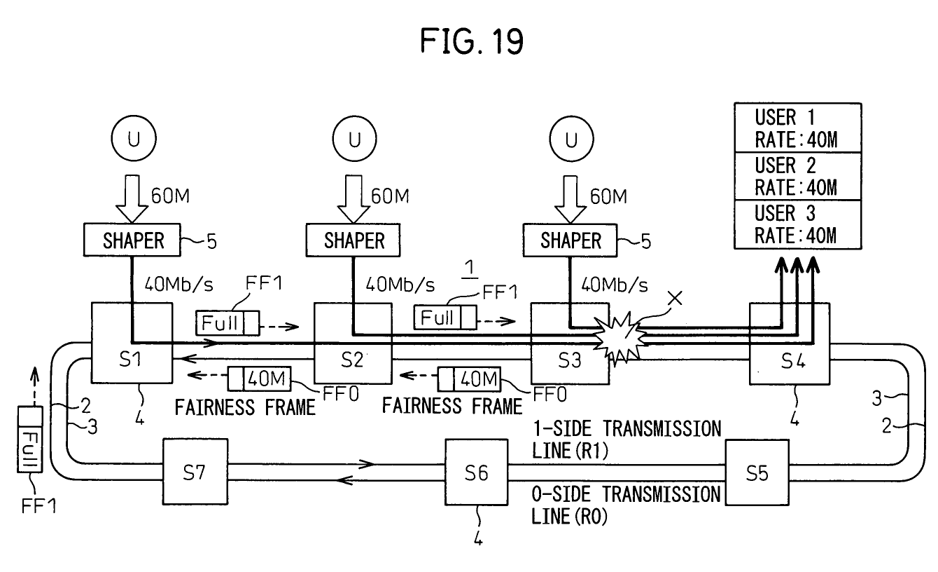

FIG. 18 shows the mode by which packets are sent onto a transmission line from one station (S1) 4, but in practice, packets are also simultaneously sent from other stations (S2, S3, S4, etc.) toward their destinations. When packets are simultaneously transmitted from a plurality of stations 4 toward the same destination station 4, the possibility arises of the occurrence of congestion on the transmission line close to the destination station. FIG. 19 shows this.

In FIG. 19, the network is basically comprised by a 0-side transmission line 2 forming the route R0, a 1-side transmission line 3 forming the route R1, and a plurality of (seven in the present drawing) stations (S1 to S7) 4 in the same way as FIG. 18 described above. According to the example of this figure, users U under the first, second, and third stations (S1, S2, and S3) 4 try to transmit packets toward the destination station (S4) 4 through the 0-side transmission line (R0) 2 via shapers 5 (it is assumed that no packet transmission from the other station occurs). In addition, each user tries to transmit packets at a rate of 60 Mb/s (hereinafter simply referred to as M). Note that, in this case, assume that the permissible transmission rate (ringlet capacity) of each transmission line (2, 3) is 120 M. Also, assume that station weights are equal to each other.

This being the case, congestion occurs at the location of the mark X in the figure in traffic toward the destination station (S4) 4 from the illustrated three users U. This is because the total transmission by the three users U becomes 180 (=3×60) M, but the capacity of the transmission line 2 is 120 M as described above, so the capacity is short by 60 (=180−120) M. Here, the congestion (X) described above occurs. Namely, the RPR network is a shared bandwidth type network, therefore, there is a case where congestion is induced by best effort type traffic (fairness eligible traffic).

Even at the time of such congestion, in an RPR network, a function called a “fairness algorithm” is prepared so as not to cause unfairness among stations (4). The permissible bandwidth (120 M) can be fairly distributed among the stations (4) as represented in FIG. 19 by using a control frame called a “fairness frame”.

As shown in the figure, users U equally reduce their initial desired bandwidths from 60 M to 40 M to maintain the permissible bandwidth 120 (=40×3) M.

The users U are able to equally reduce their bandwidths to 40 M in this way because they use the above-described fairness algorithm. This fairness algorithm can be explained simply as follows.

Regarding the state of transmission of packets over the route R0 through the 0-side transmission line 2, each station generates a fairness frame FF0. The generated FF0 is transmitted in the opposite direction to the flow of the packet transmission, that is, the upstream side. Accordingly, this fairness frame FF0 is transmitted through the 1-side transmission line 3.

In the same way as the above, regarding the state of transmission of packets over the route R1 through the 1-side transmission line 3, each station 4 generates a fairness frame FF1. The generated FF1 is transmitted in the opposite direction to the flow of the packet transmission, that is, the upstream side. Accordingly, this fairness frame FF1 is transmitted through the 0-side transmission line 2. When viewing the 1-side transmission line 3, in the example of the figure, no packet transmission is carried out, therefore the rate of packets which each station 4 can send over the 1-side transmission line 3 is “full”. A fairness frame FF1 describing “full” is sent out through the 0-side transmission line 2 of each station 4 to the upstream side (clockwise direction) of the flow of the 1-side packet transmission (counterclockwise direction). Here, “full” indicates that a user can transmit packets at the desired capacity.

Next, look at the 0-side transmission line 2 side suffering from congestion (X). In an RPR network, complete priority is given to the packets from the upstream side, therefore the occurrence of congestion can be considered to reduce the rate of the packets transmitted by the third station (S3) 4 closest to the congestion to 0. In this case, 0 is described in the fairness frame FF0 which is then sent to the upstream side. The upstream side station S2 viewing this FF0 and the station S1 reduce the rates of packets transmitted from S2 and S1 toward 0 and transmit fairness frames FF0 describing 0 to their upstream sides.

Then, the rates of the packets which can be transmitted gradually increase, so the station (S3) 4 transmits the fairness frame FF0 describing a larger rate (for example 60 M) than the equal rate (40 M) toward the upstream side. The upstream side stations S2 and S3 receiving this learn that they have reduced their rates too much and increase their rates again and start transmission of the packets. In that case, the rates are gradually increased.

Along with the repetition of this operation, finally, the rate of packet transmission from each station (S1, S2, S3) 4 reaches 40 M, that is, the sum of the transmission rates from these three stations reaches the 120 (=3×40) M permissible transmission rate of the 0-side transmission line 2. The network then settles down to a stable state at the maximum transmission rate. This is the “fairness algorithm”. Accordingly, the stations 4 transmit fairness frames FF0 describing 40 M to the upstream sides in the stable state as shown in the figure.

In this way, the RPR network 1 using the fairness algorithm has the excellent feature that stations 4 share bandwidth and avoid congestion. However, this fairness algorithm is independent for each transmission line. Therefore, the 0-side transmission line 2 is not aware at all of the state of congestion of the 1-side transmission line 3. That is, as shown in FIG. 19, even if the 1-side transmission line 3 is completely idle, when the 0-side transmission line 2 is congested, the 0-side transmission line 2 does not operate other than to divide its bandwidth among the stations 4. Accordingly, irrespective of the fact that the 1-side transmission line 3 is idle, the congested 0-side transmission line 2 is continuously used, so the bandwidth cannot be effectively utilized. Incidentally, the standard specifications of RPR networks (IEEE802.17) do not consider use of the opposite side transmission line at all. Accordingly, it naturally does not establish any provisions regarding this.

As clear from the above explanation, current RPR networks only restrict the 60 M desired throughput of each user U to 40 M to avoid congestion. Accordingly, the users never receive fully satisfactory service.

Therefore, the present invention, as explained above, is based on the idea of transferring all or part of the 0-side (1-side) traffic to the opposite side 1-side (or 0-side) transmission line 3 (2) when congestion occurs on the 0-side (or 1-side) transmission line 2 (3) so as to relieve the congestion.

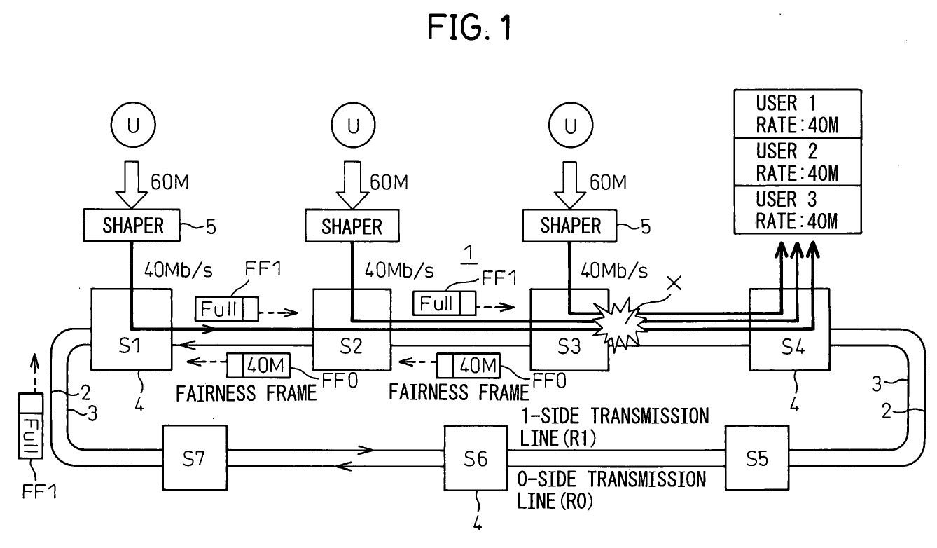

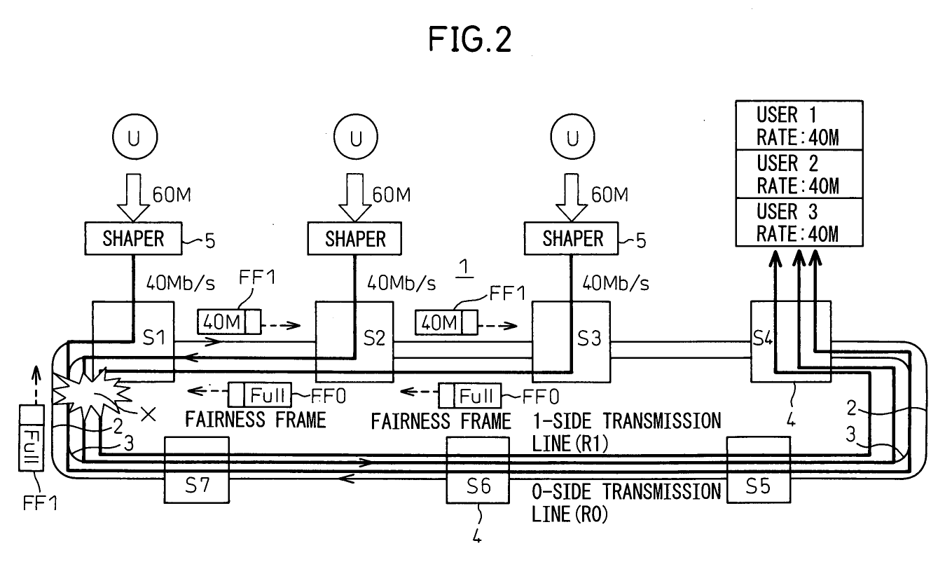

However, as previously explained, it is not easy to transfer the load to the opposite side transmission line without network trouble. This will be explained by referring to FIG. 1 and FIG. 2.

FIG. 1 and FIG. 2 are views for explaining the inherent problems in the basic concept of the present invention. Note that the same components throughout all the drawings are indicated by the same reference numerals or symbols.

Referring to FIG. 1 first, the state of traffic shown in the figure is the same as the state of traffic shown in FIG. 19 explained before, i.e., the state with congestion (X). Using the fairness algorithm explained above, the users U restrict the desired 60 M packet transmission rates to 40 M to share the permissible bandwidth 120 M of the transmission line.

Here, according to the basic concept of the present invention, each station 4 can try to avoid the congestion by using the opposite side 1-side transmission line 3 under such congestion. In the case of the example of FIG. 1, “Full” is described in the 1-side fairness frame FF1. This indicates that there is sufficient idle capacity at the 1-side transmission line 3. Therefore, the group of stations (S1, S2, S3) causing the congestion switch the 0-side transmission line 2 now in use to the opposite side 1-side transmission line 3 all together. FIG. 2 shows this state of traffic.

Referring to FIG. 2, the group switching of the transmission line explained above by the group of stations (S1, S2, S3) 4 suffering from congestion can cause congestion (X) at the 1-side transmission line 3 in the same way as explained before.

In conclusion, the objects of the present invention cannot be achieved when switching to the opposite side transmission line according to the present invention without any particular order. In other words, an adjustment mechanism is necessary for adjusting (i) when and (ii) what station should switch transmission lines by (iii) what method. This adjustment mechanism will be explained in detail below.

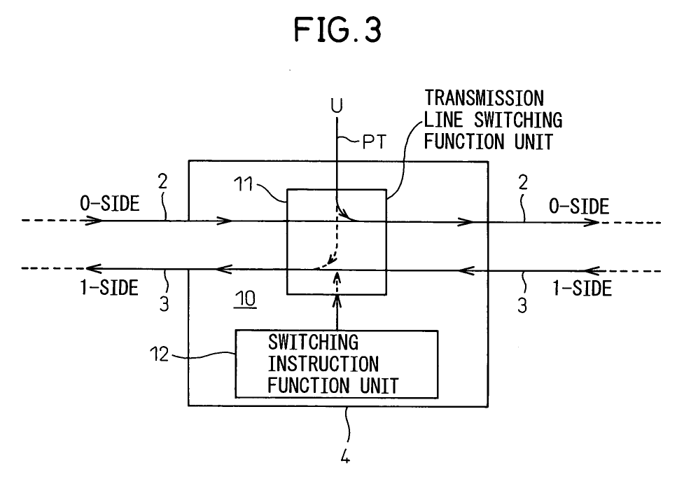

FIG. 3 is a view summarizing the adjustment mechanism formed in the station 4. In this figure, reference numeral 4 indicates the station explained above. In this station 4, the above adjustment mechanism is shown by reference numeral 10. This adjustment mechanism 10 is configured by a transmission line switching function unit 11 and a switching instruction function unit 12.

Here, the station 4 upon which the present invention is predicated is a station forming part of a packet ring telecommunications network sharing the available bandwidth for packets transmitted in a first direction (for example clockwise direction) through the 0-side transmission line 2 based on information indicated in control frames (FF0, FF1) transmitted in a second direction (for example counterclockwise direction) in the opposite direction to the first direction through the 1-side transmission line 3 forming a double ring together with this 0-side transmission line 2.

Here, the transmission line switching function unit 11 switches from the 0-side transmission line 2 to the 1-side transmission line 3 for transmitting packets. The switching instruction function unit 12 holds a switching condition determining whether or not to start the above transmission line switching operation. It refers to at least the information indicated in the above control frames (FF0, FF1) to judge if the switching condition has been satisfied. If satisfied, it issues an instruction to the transmission line switching function unit 11 to start the transmission line switching operation.

In this case, according to a preferred aspect of the present invention, the above packet ring telecommunications network is a resilient packet ring (RPR) network, the above control frames are fairness frames (FF0, FF1), and the information in the control frames are fair rate values.

Explaining this a little more specifically, the basic concept of the present invention is to clearly set in advance the standards for stations (nodes) to be switched and traffic, utilize the information of the fairness frames used in the RPR network, and switch only traffic meeting the switching condition. That is, any station (node) on the RPR network can autonomously judge whether to switch traffic. At this time, it does not use its own control frame, but only the information created by the fairness frame according to the standards of the RPR network. However, with this method, since stations can autonomously change the transmission line for transmitting the packets, they are liable to misuse the opposite side transmission line and conversely cause a drop in the throughput and new congestion. Therefore, unified clear standard is set for “when” “which station (node)” can change “which traffic” by “what method”. A specific embodiment of this will be explained below, but an example of the RPR network to which the present invention is applied will be shown before that.

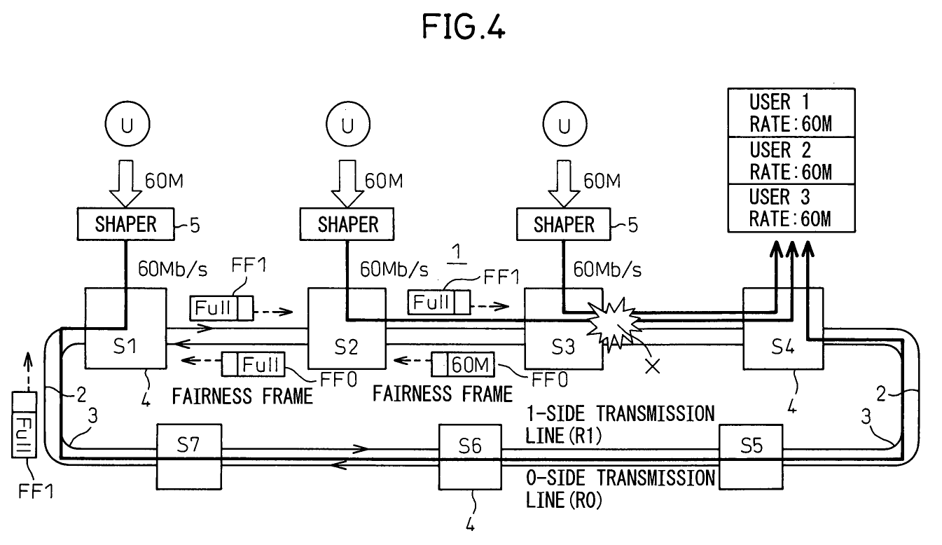

FIG. 4 is a view of an example of the configuration of an RPR network to which the present invention is applied. It should be noted in the figure that, the fair rate value described in the fairness frame FF1 from the 0-side transmission line 2 side for the 1-side transmission line 3 indicates “Full”, therefore, for example the first station (S1) 4 learns that no congestion has occurred in the 1-side transmission line 3, so this station S1 transmits the packets from the user U under the station S1 by switching from the 0-side transmission line 2 to the 1-side transmission line 3. Thus, all of the stations (S1, S2, S3) 4 become able to transmit packets at the desired 60 M rate. Note that the figure shows a state where other packets are not transmitted on the 1-side transmission line 3, therefore, if close to the permissible capacity (120 M) of packets are already being sent on this 1-side transmission line 3, the above-described transmission line switching does not succeed. Below, various aspects of the switching instruction function unit 12 (FIG. 3) will be explained.

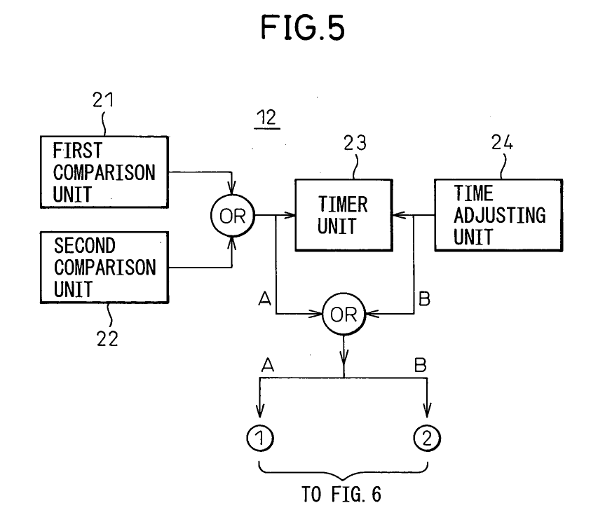

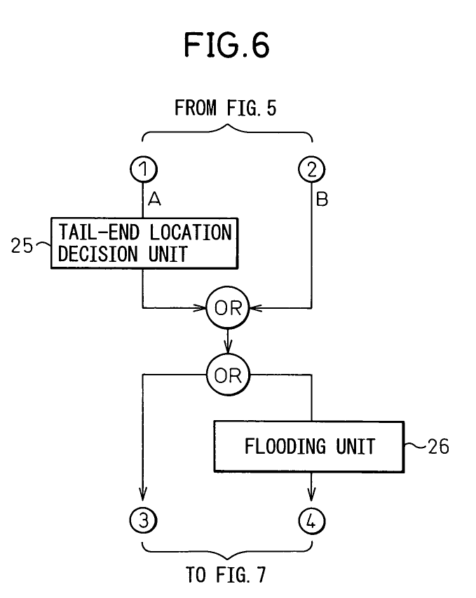

FIG. 5 to FIG. 8 are views representing functions of the switching instruction function unit 12 by hardware images. These views show functions of the switching instruction function unit 12 by hardware images for easy understanding, but in actuality most of the functions are realized by software by a CPU. Also, the parts are shown arranged in the time sequence of the switching control sequence.

Referring to FIG. 5 first, the switching instruction function unit 12 includes a first comparison unit 21. This first comparison unit 21 compares the magnitudes of the 0-side fair rate value in the 0-side fairness frame FF0 received through the 1-side transmission line 3 for the packets transmitted through the 0-side transmission line 2 and of the 1-side fair rate value in the 1-side fairness frame FF1 received through the 0-side transmission line 2 for the packets on the 1-side transmission line 3 on the opposite side to that. When judging that the switching condition that the “1-side fair rate value is larger” is satisfied as a result of the comparison, the first comparison unit 21 issues an instruction to start the transmission line switching operation.

For example, when referring to the example of FIG. 1, in the stations S1 and S2, the 0-side fair rate value in the 0-side fairness frame FF0 concerning the 0-side transmission line 2 is 40 M, and the 1-side fair rate value in the 1-side fairness frame FF1 concerning the 1-side transmission line 3 is “Full” (Full>40). Therefore, here, the switching condition that the “1-side fair rate value is larger” is satisfied, and an instruction to start the transmission line switching operation is issued. Accordingly, the actual transmission line switching has not yet been started.

Up to here, in place of the first comparison unit 21, the second comparison unit 22 may also be used. Namely, the switching instruction function unit 12 includes a second comparison unit 22. This second comparison unit 22 compares the magnitudes of the 0-side fair rate value in the 0-side fairness frame FF0 received through the 1-side transmission line 3 for the packets transmitted through the 0-side transmission line 2 and of a predetermined fair rate value. When judging as a result of the comparison that the switching condition that the “0-side fair rate value is lower than the predetermined fair rate value” is satisfied, the switching instruction function unit 12 issues an instruction to start the transmission line switching operation. Accordingly, the actual transmission line switching has not yet been started.

For example, if the predetermined fair rate value is set to 30 M, when the actual 0-side fair rate value is lower than this 30 M, it is estimated that the degree of congestion is large, and transfer of the traffic to the opposite side 1-side transmission line 3 is attempted.

The present invention may employ either of the first comparison unit 21 and the second comparison unit 22. Note that both cannot be simultaneously employed, therefore either is employed. For this reason, FIG. 5 shows “OR” at the output sides of these first and second comparison units (21, 22) meaning that either one is employed (hereinafter, “OR” indicates that only one is employed in the same way).

According to the present invention, by using the configuration of FIG. 3 described above, it becomes possible to efficiently transmit packet data of the fairness eligible traffic of an RPR network.

Also, in FIG. 5 described above, it is possible to use the first comparison unit 21 to standardize the switching timings when stations (nodes) 4 execute the switching. Also, the method of decision thereof is a simple method comprising comparing the magnitudes of the fair rate values of the 0-side and 1-side fairness frames, so equipping the station 4 becomes easier.

Also, it is possible to use the second comparison unit 22 in the same way as the case of the first comparison unit 21 so as to standardize the switching timings. The method of using this second comparison unit 22 is slightly more complex than the method of using the first comparison unit 21, but it becomes possible to increase or decrease the predetermined fair rate value serving as the standard value for comparison to adjust the system so that a light congestion state does not cause switching and finer setting of the switching timing becomes possible.

Referring to FIG. 5 again, the switching instruction function unit 12 includes a timer unit 23. This timer unit 23 measures whether or not the 0-side fair rate value is continuously lower than the predetermined fair rate value over a predetermined time. When this timer unit 23 decides that the switching condition “it continues for a predetermined time or more” is satisfied, it issues an instruction to start the transmission line switching operation. Namely, it confirms that the fair rate value is continuously lower than the predetermined fair rate value for a predetermined time or more in order to ascertain that the state of congestion is not light.

Further preferably, the switching instruction function unit 12 includes a time adjusting unit 24. The time adjusting unit 24 sets a predetermined time in the aforementioned switching condition long or short in accordance with the magnitude of a transit rate of the packets passing through it (4).

If the “predetermined time” decided by the timer unit 23 explained above were set at the same value for the stations 4, for example in FIG. 1, the station S3 and station S2 and station S1 would try to start the transmission line switching operation all together. However, this would cause the problem explained in FIG. 2, that is, the problem of recurrence of the congestion in the opposite side transmission line.

Therefore, in order to solve the above problems, a difference is given to the “predetermined time” among a plurality of stations (S1, S2, and S3 in the above example). This is the role of the time adjusting unit 24. The difference is given as described above so that the predetermined time is set long or short in accordance with the magnitude of the transit rate. Namely, referring to FIG. 1, when comparing the transit rates at the output sides of the stations S3, S2, and S1, the transit rate is 1 magnitude of traffic on the output side of the station S1, but builds up to 2 magnitudes of traffic on the output side of the station S2 and builds up to 3 magnitudes of traffic on the output side of S3, therefore the transit rate becomes S1:S2:S3=1:2:3. From this, the difference T3>T2>T1 is given to the predetermined time T among the stations S3 (T3), S2 (T2), and S1 (T1).

In the end, the station S1 given the shortest predetermined time (T1) first starts the transmission line switching operation. This is because, referring to FIG. 1 again, the station S1 having the smallest number of stations through which data will pass until it reaches the destination station (S4), that is, the smallest number of hops, is selected as the target of the transmission line switching in the route R1 (ringlet 1) through the opposite side transmission line, that is, the 1-side transmission line 3.

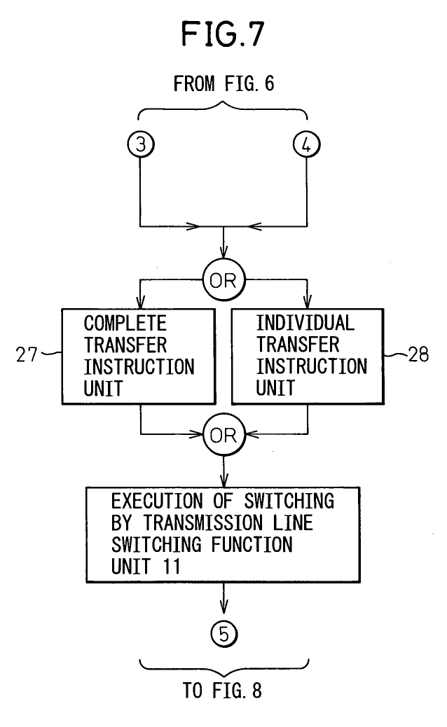

Thus, in FIG. 5, an instruction A (instruction to start the transmission line switching operation) issued by the first comparison unit 21 or the second comparison unit 22 or a second instruction B determining the stations for switching after adding the decision by the timer unit 23 to that instruction is issued. Between these instructions A and B, the instruction A only indicates the timing of the transmission line switching, therefore an instruction as to which station is next for transmission line switching must be issued. This is shown in FIG. 6.

Referring to FIG. 6, when there are a plurality of stations which must switch the transmission line based on the instruction A, one is specified. Several methods for specifying it can be considered. The tail-end location judging unit 25 is shown as a preferred example. Namely, the switching instruction function unit 12 includes the tail-end location judging unit 25. When the 0-side fair rate value in the 0-side fairness frame FF0 received through the 1-side transmission line 3 for the packets transmitted through the 0-side transmission line 2 indicates the occurrence of congestion and congestion occurs in the group of stations (refer to S1, S2, and S3 of FIG. 1), this judging unit 25 judges whether or not the position of the station (4) among the group of stations (S1 to S3) corresponds to the tail-end location of the group. When the result of the judgment is that the station S1 judges that the switching condition “it is the tail-end location” is satisfied, an instruction to start the transmission line switching operation is output to the transmission line switching function unit 11 in the station S1.

The stations S1, S2, and S3 are a group of stations which form a so-called congestion domain which becomes a cause of congestion. If this group of stations (S1 to S3) receiving the instruction A were to switch the transmission line all together, they would cause the problem explained in FIG. 2 described above. Therefore, the station (S1) at the tail-end location in the congestion domain is set as the station for transmission line switching.

In this way, referring to FIG. 1, the reason for setting the tail-end location is that, as explained before, the station S1 has the smallest number of stations through which the data will pass until it reaches the destination station (S4), that is, the smallest number of hops in the route R1 through the opposite side transmission line, that is, the 1-side transmission line 3.

As described above, by employing the tail-end location judging unit 25, it becomes possible to standardize the decision of the switching station as to which station (node) is to be switched. This method sets the condition of being the tail-end location of the congestion domain, therefore the switchable station is always limited to only one station. Accordingly, in a situation where a plurality of stations finally have to switch lines, the switching is slowly carried out one station at a time so more careful switching becomes possible.

In the case according to the instruction B explained above, it becomes possible to standardize the decision of the switching station in the same way as the above description. In the case according to this instruction B, all stations where the time during which the transmission rate is lower than a threshold value exceeds a certain predetermined time become the target of switching, therefore quicker switching becomes possible.

Also, by using the time adjusting unit 24 explained above, a switching sequence can be imparted to stations which may become targets of switching under the instruction B, and sequential switching from the tail-end location station becomes possible.

Note that, each station 4 in the congestion domain can easily decide whether it is located at the tail-end location by referring to a known topology management table (not illustrated) originally held by each station 4. The topology management table in a certain station records the information of the connections with all other stations accommodated in the same RPR network.

Thus, since the timing of the transmission line switching is determined and the station which becomes the target of transmission line switching (for example S1) is specified, the transmission line switching function unit 11 in the station (S1) switches the packets from the user U under the station S1 from the 0-side transmission line 2 to the 1-side transmission line 3 and therefore can transmit the same to the destination station S4. At this time, as previously explained, the transfer of the traffic of the packets by switching to this 1-side transmission line 3 does not always succeed. Therefore, desirably the flooding unit 26 shown in FIG. 6 is used.

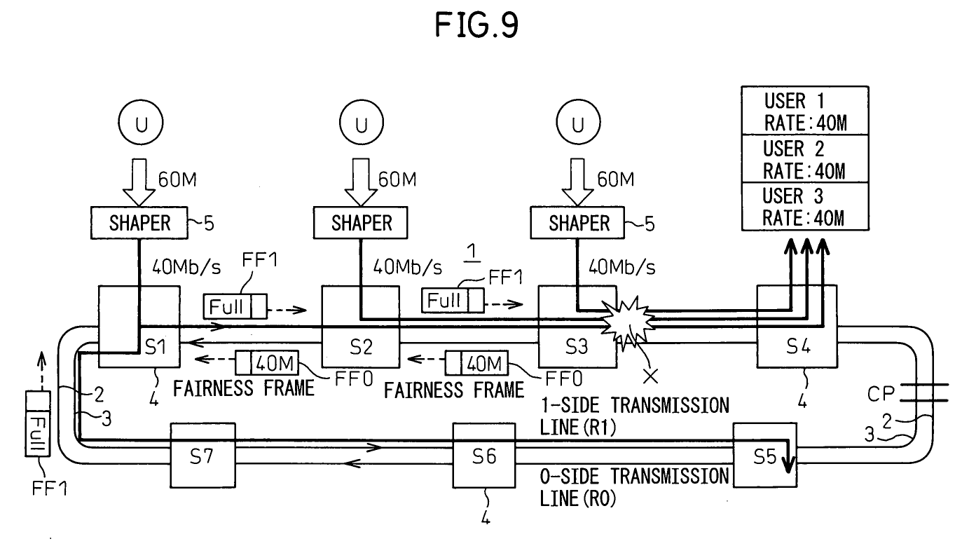

Namely, the switching instruction function unit 12 includes the flooding unit 26. This flooding unit 26 places the transmission line switching function unit 11 into a state for simultaneously selecting the 0-side and 1-side transmission lines (2, 3) prior to issuing an instruction to start the transmission line switching operation and further a flooding of copies of the packets in transmission through the 0-side transmission line 2 to the 1-side transmission line 3. Then, when judging as a result of the flooding that the switching condition that “no congestion due to flooding occurs” is satisfied, the flooding unit 26 outputs an instruction to start the transmission line switching operation to the transmission line switching function unit 11. In short, the prior investigation traffic is transmitted to the switching side for a constant time so as not to cause new congestion due to switching of the transmission line. When the congestion is not confirmed, this transmission line switching is executed first. By this, congestion in the opposite side transmission line can be predicted in advance, and unnecessary transmission line switching can be avoided. This aspect will be supplementarily explained by referring to FIG. 9.

FIG. 9 is a view representing the prior investigation of the opposite side transmission line by the flooding unit 26. The station (S1) 4 for transmission line switching as explained above investigates in advance if any problem would arise by transmitting the traffic to the opposite side transmission line 3. That is, the data flowing through only the 0-side transmission line 2 hitherto is switched to flooding. By this, the data from the station S1 will flow in the two directions of the 0-side and 1-side transmission lines up to the cleave points CP. At this time, congestion does not occur in the opposite side transmission line 3, therefore the station S1 decides to switch the traffic to this opposite side transmission line.

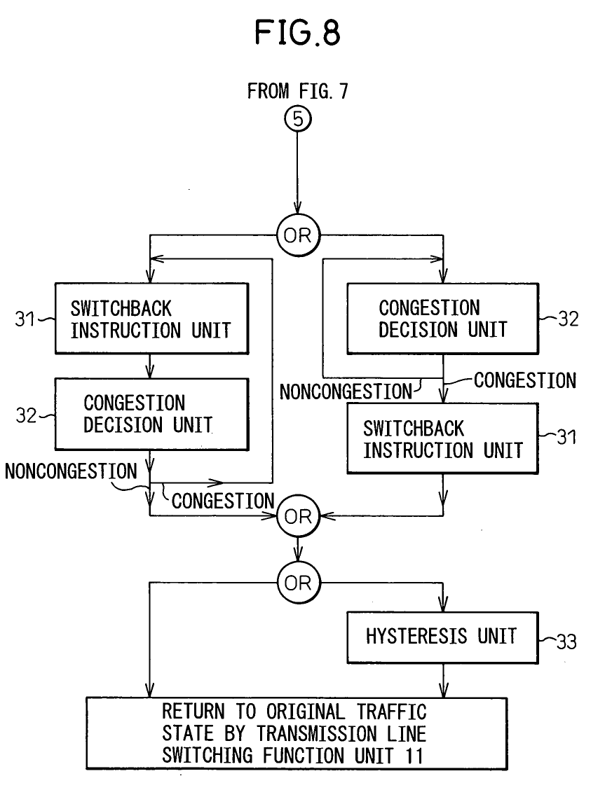

Here, the station (S1) 4 actually executes the switching by the transmission line switching function unit 11. There are two modes for switching in this case as shown in FIG. 7. The first switching mode is the “complete transfer” system, while the second switching mode is the “individual transfer” system.

Under the “complete transfer” system, the switching instruction function unit 12 includes a complete transfer instruction unit 27 for transferring all traffic in the middle of transmission through the 0-side transmission line 2 to the 1-side transmission line 3 when the transmission line switching operation is to be started.

On the other hand, under the “individual transfer” system, the switching instruction function unit 12 includes an individual transfer instruction unit 28 for deciding whether or not to transfer the traffic to the 1-side transmission line 3 for each destination station of the traffic in the middle of transmission through the 0-side transmission line 2 and issuing the instruction of the transfer when starting the transmission line switching operation.

When determining which traffic is to be switched, first, the simplest method is to switch all traffic flowing in the transmission line suffering from congestion to the opposite transmission line (above “complete transfer” system). This method has the advantage that the control is easy and quick switching can be carried out.

However, when a large amount of data is being transmitted from a certain station, if all traffic were to be switched to the opposite side transmission line, congestion might be caused in this opposite side transmission line. For this reason, the method of switching traffic in units of destination stations would be effective (above “individual transfer” system).

By using the above “complete transfer” system (27), traffic from a certain station can be transmitted to the opposite side transmission line at one time, therefore quicker switching becomes possible. This is effective when the total amount of traffic from that station is not so large.

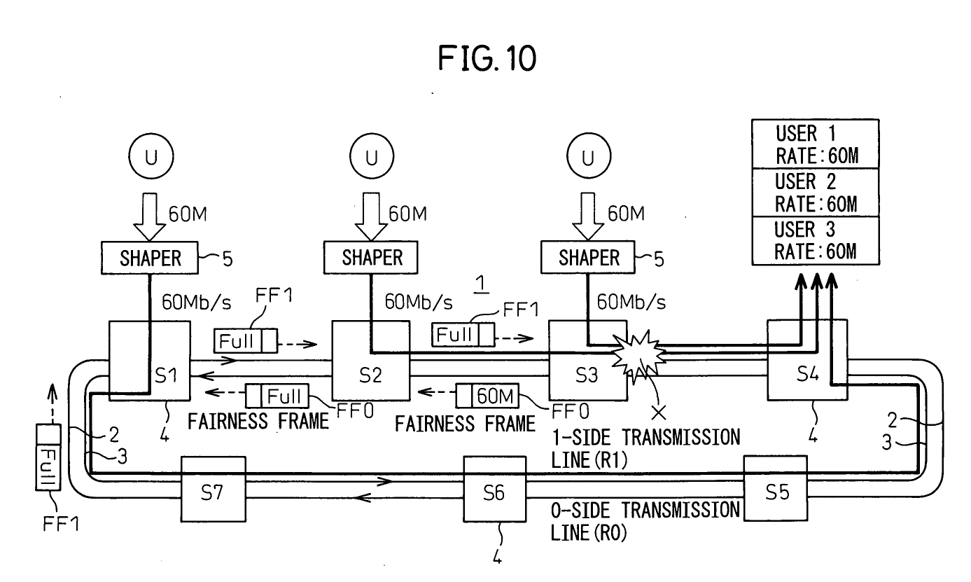

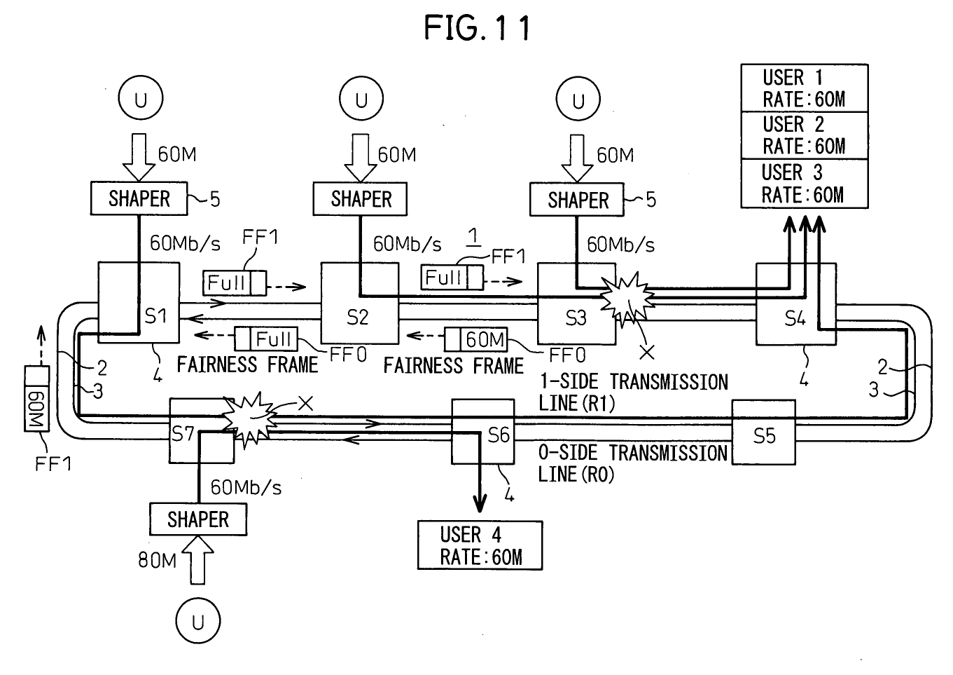

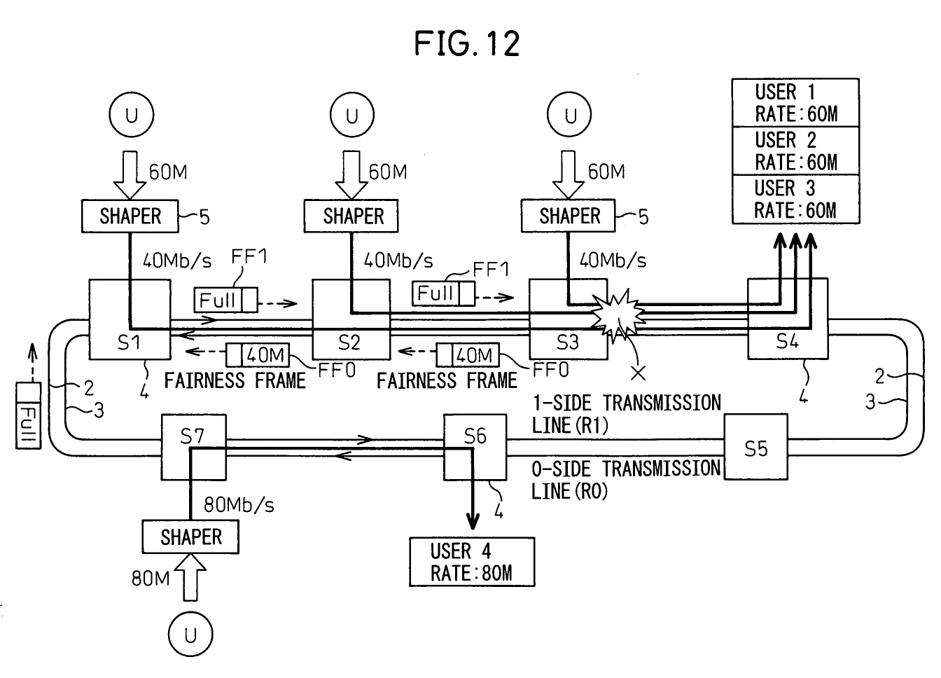

On the other hand, by using the above “individual transfer” system (28), fine switching in units of the destination station becomes possible. This is effective when the total amount of traffic from that station is large and switching at one time would have a large impact on the opposite side transmission line. Note that the detailed state of the network when the above “complete transfer” system is employed will be explained later (refer to FIG. 10, FIG. 11, and FIG. 12).

Thus, the transfer of the traffic to the opposite side transmission line is completed in the last stage of FIG. 7. However, the technique of improvement of the throughput by utilizing the opposite side transmission line did not originally envision an RPR network. Also, utilization of the same for packet transmission up to the opposite side transmission line results in a greater susceptibility to congestion compared with the time of utilization of an ordinary network.

Therefore, when to return (switch back) temporary traffic being transferred to the opposite side transmission line to the original transmission line becomes important. Explaining this switchback by referring to FIG. 8, the switchback method at the left side in the figure (first switchback mode) and the switchback method at the right side of the figure (second switchback mode) may be considered. First, explaining this by the first switchback mode (left side), it becomes as follows.

The switching instruction function unit 12 has a switchback instruction unit 31 and a congestion decision unit 32. The congestion decision unit 32 decides whether or not congestion is still occurring in the original 0-side transmission line after execution of the transmission line switching operation. When judging as a result of the decision that the switching condition “no occurrence of congestion in the 0-side transmission line” is satisfied, the switchback instruction unit 31 instructs the transmission line switching function unit 11 to switch back from the 1-side transmission line 3 being switched to the original 0-side transmission line 2.

In this case, the switchback instruction unit 31 periodically instructs the transmission line switching function unit 11 to switch back to the 0-side transmission line 2. Then, any congestion in the 0-side transmission line 2 after the switchback is decided in the congestion decision unit 32. Switchback to the 0-side transmission line 2 is instructed to the transmission line switching function unit 11 at the time of noncongestion.

On the other hand, when looking at the second switchback mode (right side), when the congestion decision unit 32 decides that congestion is occurring in the 1-side transmission line 3 in the middle of switching, the switchback instruction unit 31 instructs the transmission line switching function unit 11 to switch back to the 0-side transmission line 2.

In short, the method of periodically of switching back to the original transmission line to view the situation corresponds to the first switchback mode. When the congestion in the original transmission line has been eliminated, the original transmission line is switched back to. When it has not been eliminated, the switched to transmission line is maintained as it is. This is the thinking behind returning to the original transmission line as early as possible even when congestion does not occur in the opposite side transmission line.

On the other hand, the second switchback mode is the method of switching back to the original transmission line when congestion occurs in the switched to opposite side transmission line. That is, this method is based on the idea that even though that the opposite side transmission line is originally not to be used, there is no problem even if using the opposite side transmission line as it is so long as it exerts no influence upon the other stations.

As apparent from the above description, by using the method according to the first switchback mode, it becomes possible to standardize the timings for switchback. Also, by periodically switching back to the opposite side transmission line, it becomes possible to return to the original transmission line as early as possible. In the second switchback mode, in the same way as the first mode, not only does it become possible to standardize the timing of switchback, but also switchback is not carried out until congestion occurs in the opposite side transmission line. Therefore, although the opposite side transmission line is continuously used for a longer time, there is no need for the function of periodical switchback described above. Accordingly, simpler equipment is possible.

The above switchback is more preferably given hysteresis. This is done by a hysteresis unit 33 shown in FIG. 8. Namely, the switchback unit 31 cooperates with the hysteresis unit 33 so as not to switch back for a constant time even when the congestion decision unit 32 decides that the switching condition “congestion occurs in the transmission line” is satisfied.

By using this hysteresis unit 33, it becomes possible to impart hysteresis to the series of operations and exclude an unstable state where switching and switchback alternately and frequently occur.

Here, the specific state of the network when the above “complete transfer” system (“27” of FIG. 7) is employed will be explained supplementarily by referring to the drawings.

FIG. 10 is a view of the state of execution of complete transfer to the opposite side transmission line; FIG. 11 is a view of the state when congestion occurs in the opposite side transmission line after the transfer of FIG. 10; and FIG. 12 is a view of the state when switchback to the original transmission line is carried out due to the congestion of FIG. 11.

As the traffic for switching, since the “complete transfer” system described above is used, all of the traffic will be switched to the opposite side transmission line (FIG. 10). At this time, at the 1-side transmission line 3, no 1-side fairness frame (FF1) indicating congestion has arrived. Therefore, it becomes possible to raise the rate of the transmission packets to the 60 M desired by the user. Also, the stations S2 and S3 no longer carry any transit traffic from the station S1, therefore the stations S2 and S3 are allotted equal 60 M shares of the bandwidth (120 M) of the 0-side transmission line 2. That is, it becomes possible for all users to transmit packets up to 60 M.

Now assume that 80 M transmission of the packet data is started from the station S7 to the station S6 at a certain time (refer to FIG. 11). At this time, congestion occurs at the packet transmission side of the 1-side transmission line of the station S7. The 1-side fairness frame FF1 (60 M) is sent to the station S1 for notification of the occurrence of congestion. In this case, if using the switchback method according to the second switchback mode, the station S1 immediately switches to the original 0-side transmission line 2 resulting in the state shown in FIG. 12.

Here, when assuming that the stations S2 and S3 continue transmission with the same rate, the original 0-side transmission line 2 ends up returning to a congestion state the same as the prior state, so an 0-side fairness frame FF0 having the fair rate value=40 M arrives at the station S1. On the other hand, at the 1-side transmission line 3, the station S1 switches back, therefore the congestion is solved, so a 1-side fairness frame FF1 indicating the fair rate value=Full arrives at the station S1. However, when the hysteresis unit 33 of FIG. 8 is employed, the transmission line does not immediately switch to the 1-side transmission line 3 and therefore the state of the network of FIG. 12 is held for a constant time. Accordingly, when the congestion of FIG. 12 is eliminated during that constant time, the station S1 can maintain the 0-side transmission line 2 as it is.

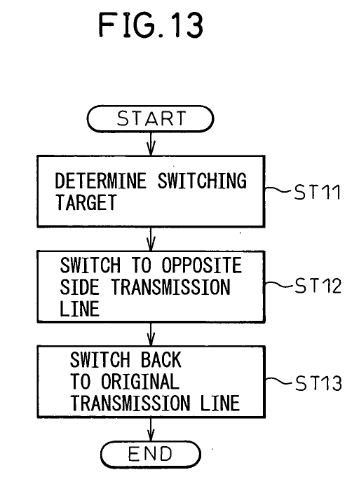

The transmission line switching according to the present invention explained above can also be grasped as a packet transmission method in the RPR network 1. This is represented in FIG. 13.

FIG. 13 is a flow chart showing the packet transmission method according to the present invention. First, the packet transmission method in the present invention is a packet transmission method in an RPR network 1 where the available bandwidth for packets from stations 4 transmitted in the first direction through the 0-side transmission line 2 is shared among a plurality of stations 4 based on the fair rate value indicated in the fairness frame (FF) transmitted in the second direction in the opposite direction to the first direction through the 1-side transmission line 3 forming the double ring together with the 0-side transmission line 2. Here,

Step ST11: When it is decided that the fair rate value received in the station 4 satisfies the predetermined switching condition, a particular switching station 4 is determined as the switching target;

Step ST12: In the particular switching station 4 determined as described above, the traffic in the middle of transmission through the 0-side transmission line 2 is switched to the 1-side transmission line 3 and transmitted.

In above first step ST11, when there are a plurality of switching stations 4 for switching described above, the switching station 4 located at the tail-end location in the direction of flow of the packets is designated as the particular switching station. Also, as the switching target, particular traffic can be further included other than that of the switching station 4 explained above.

Step ST13: After switching to the 1-side transmission line 3 in the above step ST12, the traffic is switched back again to the original 0-side transmission line 2. Further, preferably, at the time of the start of the above step ST13, a step of confirming in advance that congestion will not occur by sending predetermined packets to the 0-side transmission line 2 is included.

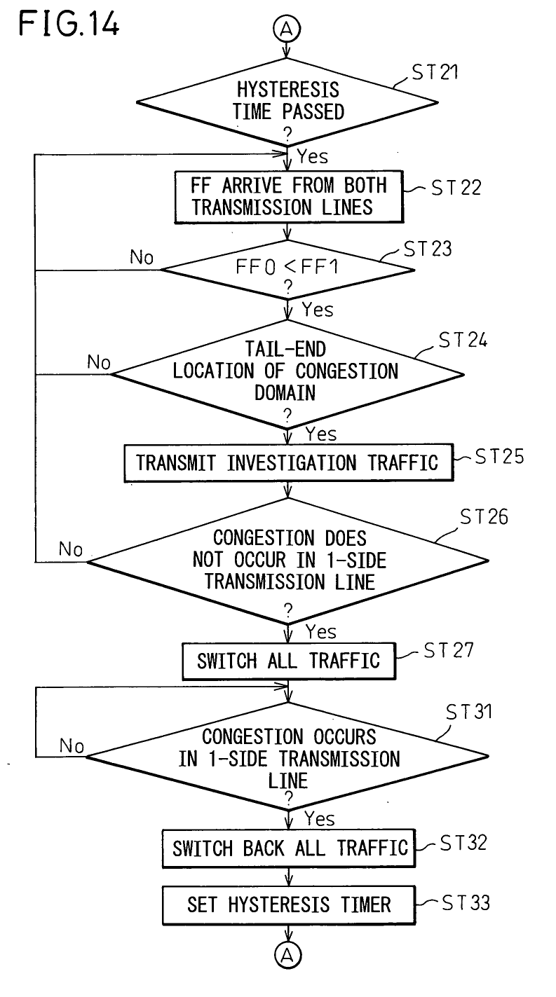

Giving a typical example using the packet transmission method explained above in the drawings, FIG. 14 is a flow chart of an example of the packet transmission method based on the present invention in the RPR network. In the figure, steps ST21 to ST27 show the flow at the time of the transmission line switching explained before, while steps ST31 to ST33 show the flow at the time of the transmission line switchback explained above.

Step ST22: Fairness frames (FF1 and FF0) arrive at the stations 4 from both the transmission lines 2 and 3; and

Step ST23: The magnitudes of the fair rate values described in the arrived fairness frames FF1 and FF0 are compared (corresponding to the comparison of magnitude by the first comparison unit 21 of FIG. 5 explained before).

Step ST24: Each station 4 learns that the timing when the operation for transmission line switching should be started has arrived when the result of judgment of step ST23 is “Yes”. Therefore, at step ST24, it is further determined at which station the transmission line switching is to be executed. For this reason, each station decides whether or not it is positioned at the tail-end location of the group of stations (congestion domain) now causing congestion in the flow of the packets (corresponding to the tail-end location judging unit 25 of FIG. 6 explained before).

Step ST25: If assuming that the tail-end location is for example the station S1, the station S1 transmits copies of the packets in the middle of transmission as the prior investigation traffic to the opposite side transmission line 3 (corresponding to the flooding unit 26 of FIG. 6 explained before).

Step ST26: The prior investigation in the above step ST25 checks if congestion is occurring in the opposite side transmission line 3. When it is confirmed that no congestion occurs (“Yes”),

Step ST27: All current traffic of the station S1 is switched to the opposite side transmission line 3 side. Here, the packet transmission by the opposite side transmission line 3 is started, so the congestion in the congestion domain is eliminated. The packet transmission by this opposite side transmission line 3 is different from ordinary packet transmission and is a temporary relief measure. Accordingly, the network must be returned to the original traffic by the 1-side transmission line as early as possible. For this reason,

Step ST31: It is checked if congestion is occurring in the switched-to opposite side transmission line 3 (corresponding to the second switchback mode in FIG. 8 explained before (right side route in the same diagram)). If that congestion is occurring,

Step ST32: All traffic is switched back to the original 0-side transmission line 2;

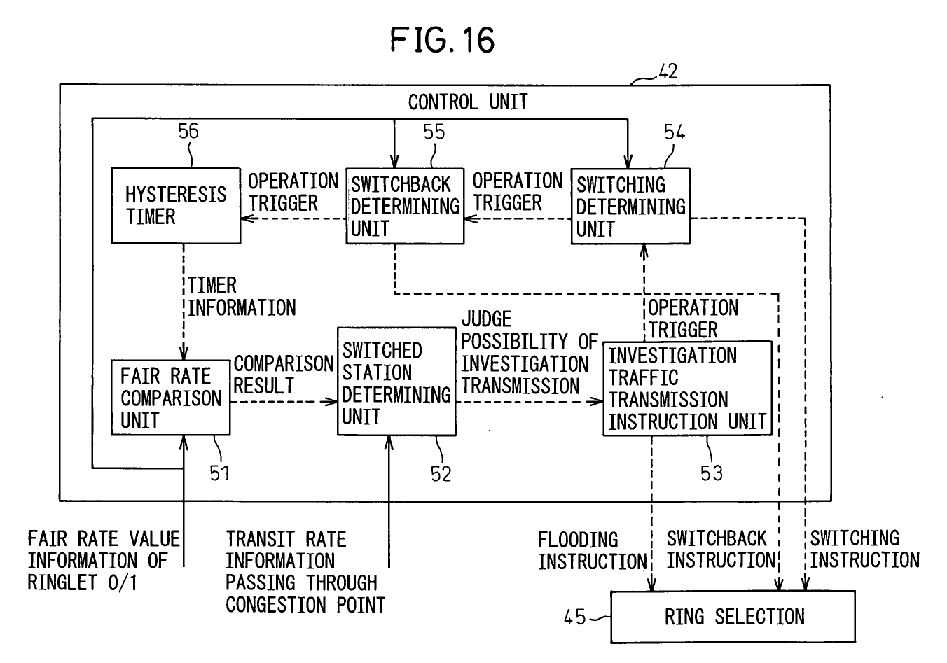

Step ST33: A hysteresis timer is set (refer to the hysteresis unit 33 of FIG. 8 explained before, 56 of FIG. 16); and

Step ST21: When the above hysteresis timer runs out of time, the routine returns to the first step ST22. The same operation is then repeated.

Finally, an example of the actual configuration of a station 4 according to the present invention will be shown. Namely, FIG. 5 to FIG. 8 explained before were views considering the sequence of transmission line switching and switchback, therefore here examples of actual configurations eliminating that sequence are shown. Note, as previously explained, these are examples of configurations by hardware images. In actuality, most of the functions are accomplished by processing of software by a CPU.

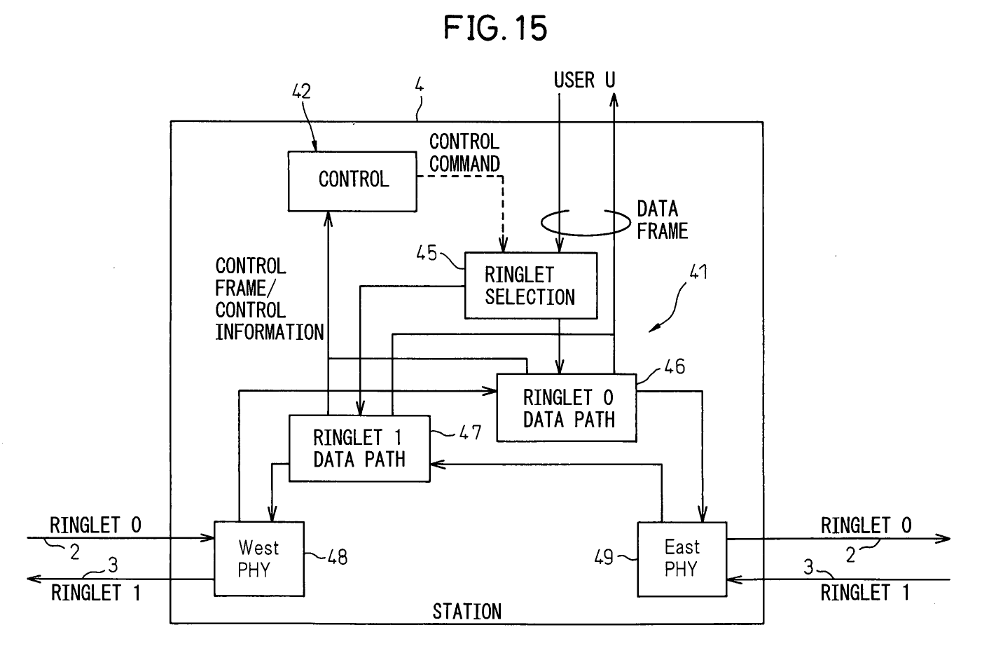

FIG. 15 shows an example of the actual configuration of a station 4; and FIG. 16 shows an example of the actual configuration of the switching control means 42 in FIG. 15. This switching control means 42 corresponds to the switching instruction function unit 12 in FIG. 3 (showing a schematic configuration of the adjustment mechanism according to the present invention). The transmission line switching function unit 11 of FIG. 3 paired with this is shown as a transmission line switching means 41 in FIG. 15. Note that the basic configuration of FIG. 15 is based on the standards of an RPR network. Accordingly, FIG. 16 shows the configuration inherent to the present invention.

The switching control means (control unit) 42 of FIG. 15 includes, as standard functions of an RPR network, an operation, administration, and maintenance (OAM) processing unit, a fairness processing unit, a topology and protection processing unit, etc., but these have no relationship with the functions of the present invention explained before, so are not explained in detail here.

The fair rate value information in the fairness frame (FF0/FF1) created from a Ringlet 0 data path portion 46 and a Ringlet 1 data path portion 47 via a first physical layer (West PHY) 48 and a second physical layer (East PHY) 49 is first sent to the fairness comparison unit 51 of FIG. 16 (corresponding to the comparison unit 21 or 22 of FIG. 5).

Here, according to the switching condition of “comparison of magnitude” explained before, it is determined whether or not transmission line switching is now to be investigated. Also, at this time, the information of the hysteresis timer 56 of FIG. 16 is referred to (see the hysteresis unit 33 of FIG. 8 and step ST33 of FIG. 14). Whether or not a predetermined constant time has passed after the past switching (see ST21 of FIG. 14) is added to the decision factor too.

The result of the comparison of the magnitude here is transferred to a switched station determining unit 52 of FIG. 16. This switched station determining unit 52 judges whether or not the station 4 is to become a target for switching according to the decision standard in the timer unit 23 and the time adjusting unit 24 in FIG. 5 or the tail-end location judging unit 25 of FIG. 6 explained before. When judging that it should be switched, the judgment of whether or not to transmit the investigation traffic is transferred to an investigation traffic sending instruction unit 53. When receiving a judgment that transmission is possible, this investigation traffic sending instruction unit 53 issues a flooding instruction to the Ringlet selection unit 45 of FIG. 15 (see the flooding unit 26 of FIG. 6 explained before) and, at the same time, starts the switch determining unit 54 of FIG. 16.

Therefore, this switch determining unit 54 collects the fair rate value information shown in the fairness frame (FF1) on the opposite side transmission line (opposite Ringlet) 3 side. When deciding that congestion is not induced by the flooding, it issues an instruction to the Ringlet selection unit 45 of FIG. 15 that the traffic is to be transferred and, at the same time, starts the switchback determining unit 55 of FIG. 16 according to the instruction by the complete transfer instruction unit 27 or the individual transfer instruction unit 28 of FIG. 7 explained before.

The started switchback determining unit 55 collects the fair rate value information for the Ringlet 0 or Ringlet 1 side and investigates whether switchback of the traffic is possible by the switchback instruction unit 31 and the congestion decision unit 32 of FIG. 8 explained before. When switchback is decided to be possible, the switchback determining unit 55 issues the Ringlet selection unit 45 of FIG. 15 a switchback instruction and, at the same time, starts the hysteresis timer 55 of FIG. 16 explained before. This hysteresis timer 56 suspends the execution of switchback for a predetermined time to avoid the occurrence of switching again. This timer information is constantly fed back to the fair rate comparison unit 51.

While the invention has been described with reference to specific embodiments chosen for purpose of illustration, it should be apparent that numerous modifications could be made thereto by those skilled in the art without departing from the basic concept and scope of the invention.

What is claimed is:

1. A station forming part of a packet ring telecommunications network designed to share available bandwidth of packets transmitted in a first direction through a 0-side transmission line based on information indicated in control frames transmitted in a second direction in an opposite direction to said first direction through a 1-side transmission line forming a double ring together with said 0-side transmission line, comprising:
a transmission line switching function unit for switching from said 0-side transmission line to said 1-side transmission line to transmit packets to be transmitted and
a switching instruction function unit for holding a switching condition of whether or not to start said transmission line switching operation and giving an instruction to start said transmission line switching operation to the transmission line switching function unit when referring to at least the information indicated in said control frames and judging that the switching condition is satisfied.

2. A station as set forth in 1, wherein said packet ring telecommunications network is a resilient packet ring (RPR) network, said control frames are fairness frames, and the information in said control frames are fair rate values.

3. A station as set forth in 2, wherein: said switching instruction function unit
includes a first comparison unit for comparing magnitudes of a 0-side fair rate value in said fairness frame received through said 1-side transmission line for the packets transmitted through said 0-side transmission line and of a 1-side fair rate value in said fairness frame received through said 0-side transmission line for the packets on said 1-side transmission line on the opposite side to that and
issues an instruction to start the transmission line switching operation when judging that a switching condition “said 1-side fair rate value is larger” is satisfied as a result of the comparison of magnitude.

4. A station as set forth in 2, wherein said switching instruction function unit
includes a second comparison unit for comparing magnitudes of a 0-side fair rate value in said fairness frame received through said 1-side transmission line for the packets transmitted through said 0-side transmission line and of a predetermined fair rate value and
issues an instruction to start said transmission line switching operation when judging that a switching condition “said 0-side fair rate value is lower than said predetermined fair rate value” is satisfied as a result of the comparison of the magnitude.

5. A station as set forth in claim 4, wherein said switching instruction function unit
includes a timer unit for measuring whether or not said 0-side fair rate value is continuously lower than said predetermined fair rate value over a predetermined time and
issues an instruction to start said transmission line switching operation when judging that a switching condition “it continues for the predetermined time or more” is satisfied.

6. A station as set forth in claim 5, wherein said switching instruction function unit includes a time adjusting unit for setting a length of said predetermined time in said switching condition in accordance with a magnitude of a transit rate of said packets passing through the station.

7. A station as set forth in claim 2, wherein said switching instruction function unit
includes a tail-end location judging unit for judging whether or not the station is positioned at a tail-end location among a group of stations when a 0-side fair rate value in said fairness frame received through said 1-side transmission line for the packets transmitted through said 0-side transmission line indicates the occurrence of congestion and the congestion occurs in said group of stations and
issues an instruction to start said transmission line switching operation when judging that a switching condition “it is the tail-end location” is satisfied.

8. A station as set forth in claim 2, wherein said switching instruction function unit
includes a flooding unit for placing said transmission line switching function unit in a state simultaneously selecting both the 0-side and 1-side transmission lines prior to issuing an instruction to start said transmission line switching operation and flooding copies of said packets in the middle of transmission through said 0-side transmission line to said 1-side transmission line and
issues an instruction to start said transmission line switching operation when judging that a switching condition “no congestion due to flooding occurs” as a result of the flooding is satisfied.

9. A station as set forth in claim 2, wherein said switching instruction function unit includes a complete transfer instruction unit for transferring all traffic in the middle of transmission through said 0-side transmission line to said 1-side transmission line.

10. A station as set forth in claim 2, wherein said switching instruction function unit includes an individual transfer instruction unit for deciding whether or not to transfer traffic to said 1-side transmission line for each destination station of traffic in the middle of transmission through said 0-side transmission line and instructing that transfer when starting said transmission line switching operation.

11. A station as set forth in claim 2, wherein said switching instruction function unit includes:
a congestion decision unit for deciding whether or not congestion is occurring in said 0-side or 1-side transmission line after execution of said transmission line switching operation and
a switchback instruction unit for instructing said transmission line switching function unit to switch back from said 1-side transmission line currently in the middle of switching to said original 0-side transmission line when judging that said switching condition “no occurrence of congestion in the 0-side transmission line” is satisfied as a result of the decision.

12. A station as set forth in claim 11, wherein said switchback instruction unit periodically instructs said transmission line switching function unit to switch back to said 0-side transmission line, judges at said congestion decision unit whether or not congestion has occurred in the 0-side transmission line after the switchback, and instructs said transmission line switching function unit to switch back to said 0-side transmission line at the time of noncongestion.

13. A station as set forth in 11, wherein when said congestion decision unit decides that congestion has occurred in said 1-side transmission line currently being switch to, said switchback instruction unit instructs said transmission line switching function unit to switch back to said 0-side transmission line.

14. A station as set forth in 11, wherein said switch back unit includes a hysteresis unit which prevents switchback for a predetermined time even when said congestion decision unit decides that the switching condition “congestion occurs in the transmission line” is satisfied.

15. A packet transmission method in a resilient packet ring (RPR) network designed to share available bandwidth of packets from stations transmitted in a first direction through a 0-side transmission line among a plurality of stations based on a fair rate value indicated in a fairness frame transmitted in a second direction in an opposite direction to said first direction through a 1-side transmission line forming a double ring together with said 0-side transmission line, comprising:
determining a particular switching station as a target for switching when deciding that said fair rate value received in said station satisfies a predetermined switching condition (first step) and
having said determined particular switching station switch traffic in the middle of transmission through said current 0-side transmission line to said 1-side transmission line and transmit the same (second step).

16. A packet transmission method as set forth in claim 15, further comprising, in said first step, designating a switching station located at a tail-end location in the direction of flow of said packets as said particular switching station when there are a plurality of switching stations as a target for switching.

17. A packet transmission method as set forth in claim 15, further including particular traffic in addition to said switching station as said switching target.

18. A packet transmission method as set forth in claim 15, further comprising: switching back the traffic to the original 0-side transmission line after switching to said 1-side transmission line in said second step (third step).

19. A packet transmission method as set forth in claim 18, further comprising: transmitting predetermined packets to said 0-side transmission line to confirm in advance that congestion will not occur at the time of the start of said third step.
